(19) United States
(12) Patent Application Publication
(10) Pub. No.: US 2018/0251627 A1
(43) Pub. Date: Sep. 6, 2018

(54) SOLVENT SYSTEM COMPRISING A MIXTURE OF DIMETHYL SULFOXIDE AND AT LEAST ONE LACTONE

(71) Applicant: ARKEMA FRANCE, Colombes (FR)

(72) Inventor: Paul Guillaume SCHMITT, Lescar (FR)

(73) Assignee: ARKEMA FRANCE, Colombes (FR)

(21) Appl. No.: 15/756,680

(22) PCT Filed: Sep. 20, 2016
(86) PCT No.: PCT/FR2016/052376

§ 371 Date: Mar. 1, 2018

(30) Foreign Application Priority Data
Sep. 21, 2015 (FR) 1558878

(51) Int. Cl. C08K 5/41; C08K 5/1535; C08J 3/09

(52) U.S. Cl. CPC C08K 5/41; C08J 3/097; C08J 3/095; C08K 5/1535

(57) ABSTRACT

Provided is a solvent system containing from 5% to 95% by weight of a composition (A) containing dimethyl sulfoxide (DMSO), with respect to the total weight of the solvent system and from 5% to 95% by weight of a composition (B) comprising at least one lactone, with respect to the total weight of the solvent system. The solvent system has a variety of uses and is highly effective in dissolving polymer materials.

The present invention relates to the field of solvents for polymers which can be used in particular in the manufacture of films, membranes, artificial leather, polymer suede, polymer fibers, coatings, electronic circuits or batteries, in particular lithium-ion (Li-ion) batteries, or in the protection of electric cables by sheathing.

The polymers concerned by these varied applications are fluoropolymers or polymers comprising at least one X═O double bond, X being chosen from the sulfur atom, the carbon atom, an N—C group and an O—C group. More specifically, the polymers concerned are polyurethanes (PU), polyethersulfones (PES), polysulfones (PSU), poly(vinylidene fluoride)s, cellulose acetates, polyesters, polyamides, polyamide-imides and polyimides.

These polymers are today widely used, for example for their properties of mechanical strength and chemical resistance or also their extensible properties. In fact, the polymers are increasingly used in numerous applications.

Among these applications, the most frequent are those for which the polymers are in the form of films, membranes or coatings. As a general rule, the polymers have entirely advantageous applications when they are in the form of supported or unsupported films, the thickness of which varies from a few tens of nanometers to several millimeters. Another possibility is to find these polymers in the form of hollow fibers.

For such applications, the polymers first of all have to be dissolved in more or less concentrated solution, the films subsequently being obtained by removal of the solvent or solvents, for example by evaporation or by extraction using a third solvent, or any other method known to a person skilled in the art.

More particularly, the production of these films requires numerous stages, including in particular:
the synthesis of the polymer in a solvent medium,
the dissolution of the polymer in a solvent, in the case where the polymer resulting from the synthesis is in solid form, such as, for example, extrudates or beads,
the achievement of a polymer solution,
the production of a film by a process of coating with the polymer solution, followed by drying in order to evaporate the solvent.

This final stage can also be replaced by a stage of producing a film or a hollow fiber by a process of impregnation on a support with the polymer solution or of spinning the polymer solution, followed by dipping in a third solvent, making it possible to precipitate the polymer and to cause the solvent to migrate from the polymer solution toward the third solvent.

Currently, the solvents commonly used for producing polymer films are polar aprotic solvents, such as N-methyl-2-pyrrolidone (NMP), dimethylformamide (DMF) or dimethylacetamide (DMAc). However, these solvents exhibit numerous toxicological disadvantages as they are classified as CMR (Carcinogenic, Mutagenic or toxic for Reproduction) agents.

It is thus advantageous to replace these solvents by solvents exhibiting a better toxicological profile.

Dimethyl sulfoxide (DMSO) is a polar aprotic solvent which makes it possible to dissolve a certain number of polymers and in particular certain grades of poly(vinylidene fluoride) (PVDF), such as, for example, the Kynar® and Kynar Flex® products sold by Arkema or also the Solef®, Hylar®, Hylar® or Hyflon® products sold by Solvay. The use of DMSO makes it possible to obtain solutions with viscosities comparable to those obtained with NMP. However, in order to make possible this dissolution, the DMSO has to be heated to a temperature of the order of 50° C., indeed even greater than 50° C.

In addition, it has been observed that some solutions of PVDF in DMSO thus prepared are not stable over time. This is because a gelling or a cloudiness of the solution has been observed after only 1 to 2 days. The users are consequently constrained to employee the solution rapidly and in particular to rapidly apply it in order to produce the films required. These disadvantages are a brake on the replacement of NMP by DMSO. This is because it is known that PVDF is commonly stabilized in NMP.

The patent application FR 2 285 227 describes a process for the assembling of PVDF parts by adhesive bonding, the adhesive being a dilute solution of PVDF in a solvent, it being possible for said solvent to be chosen from DMF, DMAc, tetrahydrofuran (THF), DMSO, cyclohexanone (CyHone), hexamethylphosphoramide (HMPA), butyrolactone and their mixtures. One example actually shows that PVDF can be dissolved in DMF but at a temperature of 60° C.

The patent EP 0 639 106 B1 teaches the preparation of membranes by using solvent/cosolvent mixtures which make it possible to dissolve PVDFs at any temperature. Although numerous possible mixtures are provided, it clearly emerges from this teaching that only the mixtures based on NMP and on DMF or on n-butyl acetate are effective and are the only ones to be exemplified.

The patent application EP 0 223 709 A2 also describes a process for the preparation of porous membranes by dissolution of a fluoropolymer in a solvent. The solvents suitable for this process are chosen from ketones, ethers, amides and sulfoxides, and also their mixtures. The best solvent is indicated to be the acetone/DMF mixture, which is confirmed by the examples, which illustrate only this single mixture of solvents. In addition, these examples teach that the dissolution has to be carried out under hot conditions and that the polymer solution has to be used immediately.

The patent EP 0 574 957 B1 describes composite acrylonitrile-PVDF membranes which can be used in separation operations. The constituent polymers of the membranes can be dissolved in a solvent chosen from NMP, DMF, DMSO, HMPA, DMAc, dioxane and their mixtures, optionally in the presence of cosolvents chosen from acetone, methanol, ethanol, formamide, water or methyl ethyl ketone. The examples presented show only polyacrylonitrile (PAN) membranes and their good resistances to attacks of solvents, such as NMP, DMF, DMSO, toluene, methyl ethyl ketone or acetone.

The patent EP 1 725 703 describes the manufacture of polymer fibers in a solvent chosen from numerous solvents, including DMSO and γ-butyrolactone. There is nothing in this document to suggest an advantage in using a mixture of DMSO and of lactone.

The patent KR100868536 describes the manufacture of textile suede made of polyurethane starting from a DMSO-based polymer solution.

The patent JP1266811 describes the manufacture of membranes made of hollow polyethersulfone fibers starting from DMSO-containing polymer solutions.

The patent WO2012/173938 describes the manufacture of polyols which can be used to produce polyurethanes or polyurethane prepolymers still containing polyols. It is indicated, in order to use these prepolymers, that the addition of a solvent is possible. DMSO and some lactones are mentioned, inter alia. There is nothing in this document to suggest an advantage in using a mixture of DMSO and of lactone.

The patent EP 1 578 521 describes the manufacture of membranes made of hollow fibers based on hydrophobic (such as polyethersulfone) and hydrophilic (such as polyvinylpyrrolidone) polymers. DMSO and butyrolactone, alone or as a mixture, are mentioned as potential solvents for polymers. There is nothing in this document to suggest an advantage in using a mixture of DMSO and of lactone.

Furthermore, it is known that DMSO alone or butyrolactone alone makes it possible to dissolve numerous polymers, such as certain polyurethanes, polyethersulfones or polysulfones, by heating these solutions at approximately 50° C. for several hours, but the polymer solutions obtained gel very rapidly after returning to the working temperatures (from 0 to 20° C.). However, no document of the prior art appears to show advantages in using mixtures comprising DMSO and one or more lactones.

Thus, among these techniques known today of the prior art, none of them is satisfactory as none of them can be applied as a technique for which the solvent systems for fluoropolymers or polymers comprising at least one X═O double bond, X being chosen from the sulfur atom, the carbon atom, an N—C group and an O—C group, can advantageously replace the reference solvents, which are NMP, DMF and DMAc.

The techniques of the prior art teach that the solutions obtained are not stable over time. This is because they have a tendency to gel, whether at ambient temperature or at the temperature at which the polymer solution is formed. This problem of stability of the polymer solutions implies that it is very difficult to carry out an industrial process without significantly adapting said process.

Thus, one of the objectives of the present invention is to provide a solvent system which does not exhibit the abovementioned disadvantages encountered in the prior art.

More specifically, a first objective of the present invention is to provide a solvent system which is less toxic than NMP, DMF and DMAc, in particular which is slightly toxic, indeed even nontoxic.

Yet another objective is to provide a solvent system for fluoropolymers or polymers comprising at least one X═O double bond, X being chosen from the sulfur atom, the carbon atom, an N—C group and an O—C group, resulting in solutions which are stable over time, that is to say solutions, the stability of which over time is sufficient to make possible an industrial use, that is to say over several weeks, indeed even similar to the stability obtained with solutions in NMP, DMF and DMAc, and generally more stable than with the known solvents of the prior art, such as NMP, DMSO, ketones or DMAC.

It has now been discovered that the abovementioned objectives can be achieved, in all or at least in part, by virtue of the solvent system of the present invention.

A subject matter of the invention is thus a solvent system comprising:
from 5% to 95% by weight of a composition (A) comprising dimethyl sulfoxide (DMSO), with respect to the total weight of the solvent system; and
from 5% to 95% by weight of a composition (B) comprising at least one lactone, with respect to the total weight of the solvent system.

This is because it has been discovered, surprisingly, that the solvent system according to the invention makes it possible to obtain solutions of fluoropolymers or of polymers comprising at least one X═O double bond, X being chosen from the sulfur atom, the carbon atom, an N—C group and an O—C group, in particular polyurethanes, polyethersulfones and polysulfones, which are stable over time. Surprisingly, the solutions of polymers obtained with the solvent system according to the invention are much more stable than the solutions of polymers obtained with DMSO alone or a lactone alone.

Another subject matter of the invention is the use of the solvent system as defined above for the dissolution of fluoropolymers or of polymers comprising at least one X═O double bond, X being chosen from the sulfur atom, the carbon atom, an N—C group and an O—C group, in particular polyurethanes, polyethersulfones and polysulfones.

Another subject matter of the invention is a process for the dissolution of a polymer, such as those mentioned above.

The invention also relates to a solution comprising at least one polymer, such as those mentioned above, and at least one solvent system, as defined above.

Finally, the invention relates to the use of the solvent system according to the invention or of the solution according to the invention for the manufacture of films, artificial leather, polymer suede, polymer fibers, coatings, membranes, batteries or electronic circuits or for the protection of electric cables.

Other advantages and characteristics of the invention will become more clearly apparent on examining the detailed description.

Furthermore, it is specified that the expressions “between . . . and . . . ”, “of between . . . and . . . ” and “from . . . to . . . ” used in the present description should be understood as including each of the limits mentioned.

The solvent system of the present invention comprises from 5% to 95% by weight of a composition (A) comprising DMSO, with respect to the total weight of the solvent system.

According to a specific embodiment, the composition (A) comprises DMSO alone.

DMSO alone, or more simply DMSO, is understood to mean that the composition (A) comprises more than 80% by weight, preferably more than 90% by weight, more preferably still more than 95% by weight, of DMSO, with respect to the total weight of the composition, it being possible for the remainder to consist of impurities intrinsic to the manufacture of DMSO, after optional purification (as described in WO 1997/019047, EP 0 878 454, EP 0 878 466), and/or of odorous agents (as described in WO 2011/012820), and/or of any other additive known to a person skilled in the art, such as, for example and without limitation, stabilizers, colorants, UV stabilizers, preservatives or biocides.

The solvent system according to the invention comprises from 5% to 95% by weight of a composition (B) comprising at least one lactone, with respect to the total weight of the solvent system.

Preferably, the lactone comprises from 4 to 12 carbon atoms, said lactone being saturated or unsaturated and optionally substituted by one or more C₁-C₁₀ alkyl chains.

Preferably, the lactone is chosen from γ-butyrolactone, γ-pentalactone, γ-hexalactone, γ-octalactone, δ-octalactone, γ-decalactone, δ-decalactone, γ-dodecalactone, δ-dodecalactone, 6-amyl-α-pyrone, δ-valerolactone, γ-valerolactone, ε-caprolactone, coumarin, ascorbic acid and the mixtures of two or more of them in all proportions.

The lactone, or the mixture of lactones, preferably exhibits a boiling point of between 150 and 250° C., advantageously at atmospheric pressure.

Preferably, said lactone is soluble in water.

It is understood, within the meaning of the present invention, that a lactone is soluble in water when at least 30 g, preferably 50 g, more preferably 100 g, of lactone(s) are dissolved in one liter of water at 20° C. and at atmospheric pressure, that is to say that a homogeneous solution (that is to say just one liquid phase) is obtained after stirring for 30 min.

Very particularly preferably, the lactone is chosen from γ-butyrolactone (GBL) and γ-valerolactone (GVL).

Preferably, the solvent system according to the invention comprises from 5% to 80% by weight of the composition (A) comprising DMSO, more preferably from 30% to 80% by weight, more preferably still from 30% to 65% by weight, with respect to the total weight of the solvent system.

Preferably, the solvent system according to the invention comprises from 20% to 95% by weight of a composition (B) comprising at least one lactone, more preferably from 20% to 70% by weight, more preferably still from 35% to 70% by weight, with respect to the total weight of the solvent system.

Advantageously, when the solvent system according to the invention comprises from 5% to 80% by weight of a composition (A) comprising DMSO, with respect to the total weight of the solvent system, then said system comprises from 20% to 95% by weight of a composition (B) comprising at least one lactone, with respect to the total weight of the solvent system.

Preferably, when the solvent system according to the invention comprises from 30% to 80% by weight of a composition (A) comprising DMSO, with respect to the total weight of the solvent system, then said system comprises from 20% to 70% by weight of a composition (B) comprising at least one lactone, with respect to the total weight of the solvent system.

Advantageously, when the solvent system according to the invention comprises from 30% to 65% by weight of a composition (A) comprising DMSO, with respect to the total weight of the solvent system, then said system comprises from 35% to 70% by weight of a composition (B) comprising at least one lactone, with respect to the total weight of the solvent system.

Very surprisingly, the combination of DMSO and of at least one lactone in a specific proportion leads to better results than those observed during the dissolution, in particular of polyurethanes, of polyethersulfones or of polysulfones, in DMSO alone or in a lactone alone, said results being understood in terms of stability over time.

In one embodiment of the invention, preference is given to a lactone, or a mixture of lactones, having a boiling point similar to that of DMSO, more specifically similar to that of the composition (A).

In another embodiment, preference is given to a lactone, or a mixture of lactones, forming an azeotrope with DMSO or with the composition (A).

In both these preferred embodiments, the removal of the solvent system from the polymer, in which it is dissolved, will be facilitated, it being possible for the composition (A) and the composition (B) to be thus removed simultaneously by heating, evaporation or any other means known to a person skilled in the art.

Another advantage related to the similar or identical boiling points of the composition (A) and of the composition (B) or also related to the formation of an azeotrope between the composition (A) and the composition (B) is their ease of purification and their much easier recyclability.

In another embodiment of the invention, preference is given to a lactone, or a mixture of lactones, which is/are soluble in water.

In this preferred embodiment, the removal of the solvent system from the polymer, in which it is dissolved, will be facilitated, it thus being possible for the composition (A) and the composition (B) to be simultaneously removed by dipping in a water bath or any other coagulation or phase inversion technique known to a person skilled in the art.

According to one embodiment of the invention, the solvent system comprises from 0% to 20% by weight of one or more additional solvents, with respect to the total weight of the solvent system, chosen from water; ketones, preferably chosen from acetone, methyl ethyl ketone, methyl isobutyl ketone, hexanone, cyclohexanone, ethyl amyl ketone, isophorone, trimethylcyclohexanone and diacetone alcohol; amines, preferably chosen from monoethanolamine, diethanolamine, propanolamine, butylisopropanolamine, isopropanolamine, 2-[2-(3-aminopropoxy)ethoxy]ethanol, N-(2-hydroxyethyl)diethylenetriamine, 3-methoxypropylamine, 3-isopropoxypropylamine, monoethylamine, diethylamine, diethylaminopropylamine and triethylamine; nitriles, for example acetonitrile; alcohols, preferably chosen from ethanol, methanol, propanol, isopropanol, glycerol, butanol, methylisobutylcarbinol, hexylene glycol and benzyl alcohol; ethers, preferably chosen from tetrahydrofuran, methylfuran, methyltetrahydrofuran, tetrahydropyran and glycol dialkyl ether; esters, preferably chosen from dibasic esters, dimethyl glutarate, dimethyl succinate, dimethyl adipate, butyl acetate, ethyl acetate, diethyl carbonate, dimethyl carbonate, propylene carbonate, ethyl methyl carbonate, glycerol carbonate, dimethyl 2-methylglutarate, dimethyl 2-methyladipate, dimethyl 2-methylsuccinate, n-butyl propionate, benzyl acetate and ethyl ethoxypropionate; sulfones, preferably chosen from dimethyl sulfone and sulfolane; aromatic solvents chosen from toluene and xylene; acetals, preferably chosen from methylal, ethylal, butylal, dioxolane and 2,5,7,10-tetraoxaundecane (TOU); N-butylpyrrolidone; N-isobutylpyrrolidone; N-(t-butyl)pyrrolidone; N-(n-pentyl)pyrrolidone; N-(methyl-substituted butyl)pyrrolidone; N-propyl- or N-butylpyrrolidone, the nucleus of which is methyl-substituted, or N-(methoxypropyl)pyrrolidone; dipropylene glycol dimethyl ether; polyglyme; ethyl diglyme; 1,3-dioxolane; and methyl 5-(dimethylamino)-2-methyl-5-oxopentanoate.

Advantageously, the additional solvents have a boiling point similar to that of DMSO, more specifically similar to that of the composition (A) or similar to that of the solvent system according to the invention. The additional solvents can preferably form an azeotrope with the solvent system according to the invention.

In this preferred embodiment, the removal of the solvent system from the polymer, in which it is dissolved, will be facilitated, as set out above. The presence of the additional solvent does not in any way change the method of removal of the solvent system.

The additional solvents preferably exhibit a boiling point of between 150 and 250° C., advantageously at atmospheric pressure.

Advantageously, said additional solvent is soluble in water.

It is understood, within the meaning of the present invention, that an additional solvent is soluble in water when at least 30 g, preferably 50 g, more preferably 100 g, of this additional solvent are dissolved in one liter of water at 20° C. and at atmospheric pressure, that is to say that a homogeneous solution (that is to say just one liquid phase) is obtained after stirring for 30 min.

According to another aspect, the invention relates to the use of at least one solvent system as defined above for the dissolution of fluoropolymers or of polymers comprising at least one X═O double bond, X being chosen from the sulfur atom, the carbon atom, an N—C group and an O—C group, in particular polyurethanes, polyethersulfones and polysulfones.

Preferably, the polymers are chosen from polyurethanes, polyethersulfones, polysulfones, poly(vinylidene fluoride)s, cellulose acetates, polyesters, polyamides, polyamide-imides and polyimides.

More preferably, the polymers are chosen from polyurethanes, polyethersulfones and polysulfones.

According to yet another aspect, the present invention relates to the process for dissolution of a fluoropolymer or of a polymer comprising at least one X═O double bond, X being chosen from the sulfur atom, the carbon atom, an N—C group and an O—C group, in particular polyurethanes, polyethersulfones and polysulfones, comprising at least one stage in which said polymer is brought into contact with at least one solvent system as defined above.

This contacting operation is preferably carried out with stirring, at ambient temperature or at a temperature between ambient temperature and 90° C., preferably between ambient temperature and 80° C., more preferably between ambient temperature and 70° C. The polymer can be brought into contact with at least one solvent system according to the invention in any form but, for reasons of speed of the dissolution, it is preferable for said polymer to be in the form of a powder or of granules.

The solvent system according to the present invention is entirely suitable for the dissolution of fluoropolymers or of polymers comprising at least one X═O double bond, X being chosen from the sulfur atom, the carbon atom, an N—C group and an O—C group, in particular polyurethanes, polyethersulfones and polysulfones. In other words, the solvent system of the invention makes it possible to obtain polymer solutions which are clear and stable over time.

The amount of polymer(s) which can be dissolved in the solvent system of the invention varies within wide proportions, according to the nature of the polymer and the nature of the solvent system, and is generally between 1% and 50% by weight, preferably between 1% and 40% by weight, more preferably between 1% and 25% by weight, for example approximately 15% by weight, of fluoropolymers or of polymers comprising at least one X═O double bond, X being chosen from the sulfur atom, the carbon atom, an N—C group and an O—C group, in particular polyurethanes, polyethersulfones and polysulfones, with respect to the total weight of the final solution comprising said polymer and the solvent system.

According to another aspect of the invention, the present invention relates to a solution comprising:
from 1% to 50% by weight, preferably from 1% to 40% by weight, more preferably from 1% to 25% by weight, of at least one fluoropolymer or one polymer comprising at least one X═O double bond, X being chosen from the sulfur atom, the carbon atom, an N—C group and an O—C group, in particular polyurethanes, polyethersulfones and polysulfones, with respect to the total weight of the solution, and
from 50% to 99% by weight, preferably from 60% to 99% by weight, more preferably from 75% to 99% by weight, with respect to the total weight of the solution, of at least one solvent system as defined above.

As indicated above, polyurethanes, polyethersulfones and polysulfones are well known today for their good mechanical properties and their excellent stability over time. All these qualities make them materials of choice for their uses as membranes for filtration and ultrafiltration, the manufacture of batteries, of artificial leather or of textile suede, to mention only some of their applications.

Polyurethanes, polyethersulfones, polysulfones, poly(vinylidene fluoride)s, cellulose acetates, polyesters, polyamides, polyamide-imides and polyimides, due to their solubility in the solvent system of the present invention, can thus easily be shaped by molding in a solvent medium according to the phase inversion or coagulation process (solvent casting or also wet process according to a person skilled in the art) or also be prepared in the form of sheets, fibers, hollow fibers or tubes.

The invention also relates to the use of the solvent system as defined above or of the solution as defined above for the manufacture of films, artificial leather, polymer suede, polymer films, coatings or membranes, for the protection of electric cables and in the manufacture of batteries and electronics circuits.

For the preparation of batteries, the solvent system according to the invention can comprise any type of additive and filler usually employed for the synthesis of said batteries, and in particular carbon, whether in the form of carbon or activated carbon or also in the form of carbon nanotubes (CNTs).

Other advantages and details of the invention will become more clearly apparent in the light of the examples given below solely by way of illustration and without exhibiting any limiting nature.

### EXAMPLES

### Example 1: Solution Comprising Polyurethane and a DMSO/GBL Solvent System

a) Solubility Test at T=70° C. and at Ambient Temperature

12.5% by weight of Desmoderm® KB2H polyurethane are introduced into different solvent systems comprising DMSO and γ-butyrolactone (GBL), with respect to the total weight of the solution formed by the polymer and the solvent system.

The mixture is heated to 70° C. with gentle stirring. The solubility of the solutions tested is evaluated.

The solutions are cooled to ambient temperature and the appearance of the solutions tested is evaluated.

The results are presented in table 1:

TABLE 1

| | | | | Appearance of the |
|---|---|---|---|---|
| Solution comprising | Solvent system | | | solution after |
| 12.5% by weight | (% by weight) | | Solubility at | returning to |
| of PU | DMSO | GBL | 70° C. | ambient temperature |
| A | 100 | — | Yes | Fluid |
| (comparative) | | | | |
| B | 65 | 35 | Yes | Fluid |
| (invention) | | | | |
| C | 50 | 50 | Yes | Fluid |
| (invention) | | | | |

| | | | |
|---|---|---|---|
| D | — | 100 | No dissolution observed |
| (comparative) | | | |

After a few hours, the polymer is completely dissolved, except in the case of the solution D. Fluid solutions are obtained for the solutions A to C.

It is also found that the solutions A to C exhibit a fluid appearance after they have been cooled to ambient temperature.

b) Solubility Test at T=−2° C.

The solutions are subsequently stored at low temperature (−2° C.) for several days in order to observe their stability over time.

The results are presented in table 2:

TABLE 2

| Solution | Time from which gelling of the solution is observed |
|---|---|
| A (comp.) | 2 hours |
| B (inv.) | Solution fluid after 6 days |
| C (inv.) | Solution fluid after 6 days |
| D (comp.) | No dissolution observed during test a) |

Thus, it is found that the solution A exhibits a solid appearance only two hours after it has been stored at a temperature of −2° C. This is because the solution gels very rapidly.

On the other hand, the solutions B and C still exhibit a fluid appearance after storage at this temperature for 6 days. The solution is thus stable for at least 6 days.

Thus, the solvent system according to the invention exhibits an improvement in the stability of the polymer solution, thus showing a surprising advantage in using these two solvents as a mixture.

### Example 2: Solution Comprising Polyurethane and a DMSO/GVL Solvent System

a) Solubility Test at T=70° C. and at Ambient Temperature

12.5% by weight of Desmoderm® KB2H polyurethane are introduced into different solvent systems comprising DMSO and γ-valerolactone (GVL), with respect to the total weight of the solution formed by the polymer and the solvent system.

The mixture is heated to 70° C. with gentle stirring. The solubility of the solutions tested is evaluated.

The solutions are cooled to ambient temperature and the appearance of the solutions tested is evaluated.

The results are presented in table 3:

TABLE 3

| | | | | Appearance of the |
|---|---|---|---|---|
| Solution comprising | Solvent system | | | solution after |
| 12.5% by weight | (% by weight) | | Solubility at | returning to |
| of PU | DMSO | GVL | 70° C. | ambient temperature |
| E | 100 | — | Yes | Fluid |
| (comparative) | | | | |
| F | 50 | 50 | Yes | Fluid |
| (invention) | | | | |
| G | 30 | 70 | Yes | Fluid |
| (invention) | | | | |

| | | | |
|---|---|---|---|
| H | — | 100 | No dissolution observed |
| (comparative) | | | |

After a few hours, the polymer is completely dissolved, except in the case of the solution H. Fluid solutions are obtained for the solutions E to G.

It is also found that the solutions E to G exhibit a fluid appearance after they have been cooled to ambient temperature.

b) Solubility Test at T=−2° C.

The solutions are subsequently stored at low temperature (−2° C.) for several days in order to observe their stability over time.

The results are presented in table 4:

TABLE 4

| Solution | Time from which gelling of the solution is observed |
|---|---|
| E (comp.) | Solution set solid after 1 week |
| F (inv.) | Solution stable after 1 week |
| G (inv.) | Solution stable after 1 week |
| H (comp.) | No dissolution observed during test a) |

Thus, it is found that the solution E exhibits a set-solid appearance only one week after it has been stored at a temperature of −2° C.

Other the other hand, the solutions F and G remain stable after storage at a temperature of −2° C.

Thus, the solvent system according to the invention exhibits an improvement in the stability of the polymer solution, thus showing a surprising advantage in using these two solvents as a mixture.

### Example 3: Solution Comprising Polyvinylidene Fluoride and a DMSO/GVL Solvent System

a) Solubility Test at T=70° C. and at Ambient Temperature

10% by weight of Kynar® K761 polyvinylidene fluoride are introduced into different solvent systems comprising DMSO and γ-valerolactone (GVL), with respect to the total weight of the solution formed by the polymer and the solvent system.

The mixture is heated to 70° C. with gentle stirring. The solubility of the solutions tested is evaluated.

The solutions are cooled to ambient temperature and the appearance of the solutions tested is evaluated.

The results are presented in table 5:

TABLE 5

| | | | | Appearance of the |
|---|---|---|---|---|
| Solution comprising | Solvent system | | | solution after |
| 10% by weight | (% by weight) | | Solubility at | returning to |
| of PVDF | DMSO | GVL | 70° C. | ambient temperature |
| I | 100 | — | Yes | Fluid |
| (comparative) | | | | |
| J | 80 | 20 | Yes | Fluid |
| (invention) | | | | |
| K | 50 | 50 | Yes | Fluid |
| (invention) | | | | |

| | | | |
|---|---|---|---|
| L | — | 100 | No dissolution observed |
| (comparative) | | | |

After a few hours, the polymer is completely dissolved, except in the case of the solution L. Fluid solutions are obtained for the solutions I to K.

It is also found that the solutions I to K exhibit a fluid appearance after they have been cooled to ambient temperature.

b) Solubility Test at Ambient Temperature Over Time

The solutions are subsequently stored at ambient temperature for several days in order to observe their stability over time.

The results are presented in table 6:

TABLE 6

| | Time from which cloudiness of |
|---|---|
| Solution | the solution is observed |
| I (comp.) | Solution clouded after 1 week |
| J (inv.) | Solution colorless/transparent after 2 weeks |
| K (inv.) | Solution slightly clouded after 2 weeks |
| L (comp.) | No dissolution observed during test a) |

Thus, it is found that the solution I exhibits a clouded appearance only one week after it has been stored at ambient temperature.

On the other hand, the solution K exhibits a slightly clouded appearance two weeks after it has been stored at ambient temperature.

Finally, the solution J still exhibits a colorless and transparent appearance after storage for two weeks.

Thus, the solvent system according to the invention exhibits an improvement in the stability of the polymer solution, thus showing a surprising advantage in using these two solvents as a mixture.

### Example 4: Solution Comprising a Polyethersulfone and a DMSO/GBL Solvent System

a) Solubility Test at T=70° C. and at Ambient Temperature

15% by weight of Ultrason® E3010 polyethersulfone are introduced into different solvent systems comprising DMSO and γ-butyrolactone (GBL), with respect to the total weight of the solution formed by the polymer and the solvent system.

The mixture is heated to 70° C. with gentle stirring. The solubility of the solutions tested is evaluated.

The solutions are cooled to ambient temperature and the appearance of the solutions tested is evaluated.

The results are presented in table 7:

TABLE 7

| | | | | Appearance of the |
|---|---|---|---|---|
| Solution comprising | Solvent system | | | solution after |
| 15% by weight | (% by weight) | | Solubility at | returning to |
| of PES | DMSO | GBL | 70° C. | ambient temperature |
| M | 100 | — | Yes | Liquid |
| (comparative) | | | | |
| N | 65 | 35 | Yes | Liquid |
| (invention) | | | | |
| O | 50 | 50 | Yes | Liquid |
| (invention) | | | | |
| P | — | 100 | Yes | Solid after 1 week |
| (comparative) | | | | |

After a few hours, the polymer is completely dissolved and a fluid solution is obtained for all the solutions M to P.

It is also found that the solutions M to O exhibit a fluid appearance after they have been cooled to ambient temperature for several weeks. On the other hand, the solution P exhibits a solid appearance at ambient temperature after one week.

b) Solubility Test at T=−2° C.

The solutions are subsequently stored at low temperature (−2° C.) for several days in order to observe their stability over time.

The results are presented in table 8:

TABLE 8

| | Time from which gelling of the solution is observed |
|---|---|
| M (comp.) | 2 hours |
| N (inv.) | Solution still liquid after 3 weeks |
| O (inv.) | Solution still liquid after 1 week |
| P (comp.) | ≤15 minutes |

Thus, it may be found that the solution M exhibits a solid appearance only two hours after it has been stored at a temperature of −2° C. This is because the solution gels very rapidly.

Furthermore, the solution P very rapidly exhibits a solid appearance at ambient temperature.

On the other hand, the solution O exhibits an appearance which is still liquid one week after it has been stored at a temperature of −2° C.

Finally, the solution N still exhibits a liquid appearance three weeks after it has been stored at a temperature of −2° C.

Thus, the solvent system according to the invention exhibits an improvement in the stability of the polymer solution, thus showing a surprising advantage in using these two solvents as a mixture.

### Example 5: Solution Comprising a Polysulfone and a DMSO/GVL Solvent System

a) Solubility Test at T=70° C. and at Ambient Temperature

10% by weight of Solvay Udel® P-3500 polysulfone (PSU) are introduced into different solvent systems comprising DMSO and γ-valerolactone (GVL), with respect to the total weight of the solution formed by the polymer and the solvent system.

The mixture is heated to 70° C. with gentle stirring. The solubility of the solutions tested is evaluated.

The solutions are cooled to ambient temperature and the appearance of the solutions tested is evaluated.

The results are presented in table 9:

TABLE 9

| | | | | Appearance of the |
|---|---|---|---|---|
| Solution comprising | Solvent system | | | solution after |
| 10% by weight | (% by weight) | | Solubility at | returning to |
| of PSU | DMSO | GVL | 70° C. | ambient temperature |
| Q | 100 | — | Yes | Gelled |
| (comparative) | | | | |
| R | 50 | 50 | Yes | Fluid |
| (invention) | | | | |
| S | 30 | 70 | Yes | Fluid |
| (invention) | | | | |
| T | — | 100 | Yes | Fluid |
| (comparative) | | | | |

After a few hours, the polymer is completely dissolved and a fluid solution is obtained for all the solutions Q to T.

It is also found that the solutions R to T exhibit a fluid appearance after they have been cooled to ambient temperature, except for the solution Q, which exhibits a gelled appearance.

b) Solubility Test at T=−2° C.

The solutions are subsequently stored at low temperature (−2° C.) for several days in order to observe their stability over time.

The results are presented in table 10:

TABLE 10

| Solution | Time from which gelling of the solution is observed |
|---|---|
| Q (comp.) | Solution gelled at ambient temperature |
| R (inv.) | Solution slightly viscous after 1 week |
| S (inv.) | Solution fluid after 3 weeks |
| T (comp.) | Solution set solid after 1 week |

Thus, it is found that the solution T exhibits a set-solid appearance only one week after it has been stored at a temperature of −2° C.

On the other hand, the solution R exhibits a viscous appearance one week after it has been stored at a temperature of −2° C.

Finally, the solution S still exhibits a fluid appearance one week after it has been stored at a temperature of −2° C., it additionally being possible for this fluid appearance to still be observed after storage for three weeks.

Thus, the solvent system according to the invention exhibits an improvement in the stability of the polymer solution, thus showing a surprising advantage in using these two solvents as a mixture.

1. A solvent system comprising:
from 5% to 95% by weight of a composition (A) comprising dimethyl sulfoxide (DMSO), with respect to the total weight of the solvent system; and
from 5% to 95% by weight of a composition (B) comprising at least one lactone, with respect to the total weight of the solvent system.

2. The solvent system as claimed in claim 1, in which said lactone comprises from 4 to 12 carbon atoms, said lactone being saturated or unsaturated and optionally substituted by one or more C₁-C₁₀ alkyl chains.

3. The solvent system as claimed in claim 1, in which said lactone is chosen from γ-butyrolactone, γ-pentalactone, γ-hexalactone, γ-octalactone, δ-octalactone, γ-decalactone, δ-decalactone, γ-dodecalactone, δ-dodecalactone, δ-amyl-α-pyrone, δ-valerolactone, γ-valerolactone, ε-caprolactone, coumarin and ascorbic acid.

4. The solvent system as claimed in claim 1, in which said lactone or the mixture of lactones exhibits a boiling point of between 150 and 250° C.

5. The solvent system as claimed in claim 1, in which said lactone is soluble in water.

6. The solvent system as claimed in claim 1, in which said solvent system comprises from 5% to 80% by weight of a composition (A) with respect to the total weight of the solvent system.

7. The solvent system as claimed in claim 1, in which said system comprises from 20% to 95% by weight of a composition (B) with respect to the total weight of the solvent system.

8. The solvent system as claimed in claim 1, in which said system comprises from 0% to 20% by weight of one or more additional solvent(s), with respect to the total weight of the solvent system.

9. The solvent system as claimed in claim 8, in which said additional solvent exhibits a boiling point of between 150 and 250° C.

10. The solvent system as claimed in claim 8, in which said additional solvent is soluble in water.

11-12: (canceled)

13. A process for dissolution of a fluoropolymer or of a polymer comprising at least one X═O double bond, X being chosen from the sulfur atom, the carbon atom, an N—C group and an O—C group, comprising at least one stage in which said polymer is brought into contact with at least one solvent system as defined in claim 1.

14. A solution comprising:
from 1% to 50% by weight of at least one fluoropolymer or one polymer comprising at least one X═O double bond, X being chosen from the sulfur atom, the carbon atom, an N—C group and an O—C group, with respect to the total weight of the solution, and
from 50% to 99% by weight, with respect to the total weight of the solution, of at least one solvent system as defined in claim 1.

15. (canceled)

16. The process as defined in claim 13, wherein the polymer comprising at least one X═O double bond comprises at least one member selected from the group consisting of polyurethanes, polyethersulfones, polysulfones, poly(vinylidene fluoride)s, cellulose acetates, polyesters, polyamides, polyamide-imides, and polyimides.

17. A method of preparing the solvent system as defined in claim 1 comprising combining composition (A) and composition (B).

18. A method of manufacturing a film, artificial leather, polymer suede, polymer fiber, coating, membrane, electric cable, battery or electronic circuit, comprising incorporating the solvent system as defined in claim 1 into the film, artificial leather, polymer suede, polymer fiber, coating, membrane, electric cable, battery or electronic circuit.

19. A method of preparing the solution as defined in claim 14 comprising combining the fluoropolymer or polymer comprising at least one X═O double bond and the solvent system.

20. A method of manufacturing a film, artificial leather, polymer suede, polymer fiber, coating, membrane, electric cable, battery or electronic circuit, comprising incorporating the solution as defined in claim 14 into the film, artificial leather, polymer suede, polymer fiber, coating, membrane, electric cable, battery or electronic circuit.

21. The method of claim 20, further comprising removing the solvent system.
